(19) United States
(12) Patent Application Publication
(10) Pub. No.: US 2014/0240188 A1
(43) Pub. Date: Aug. 28, 2014

(54) DUAL-POLARIZED DIPOLE ANTENNA AND CRUCIFORM COUPLING ELEMENT THEREFORE

(71) Applicant: GALTRONICS CORPORATION LTD., Tiberias (IL)

(72) Inventors: Shay MAMO, Rishon Le Zion (IL); Haim YONA, Givat Avni (IL)

(73) Assignee: GALTRONICS CORPORATION LTD., Tiberias (IL)

(21) Appl. No.: 14/190,753

(22) Filed: Feb. 26, 2014

Related U.S. Application Data
(60) Provisional application No. 61/769,315, filed on Feb. 26, 2013.

(51) Int. Cl. H01Q 21/26

(52) U.S. Cl. CPC H01Q 21/26
USPC 343/798

(57) ABSTRACT

A dual-polarized dipole antenna including a first pair of dipole arms resonating in a first frequency band, a second pair of dipole arms intersecting the first pair of dipole arms and arranged orthogonally with respect to the first pair of dipole arms, the second pair of dipole arms resonating in the first frequency band and at least one conductive cruciform element mounted on the first and second pairs of dipole arms and resonating in a second frequency band.

### REFERENCE TO RELATED APPLICATIONS

Reference is hereby made to U.S. Provisional Patent Application 61/769,315, entitled METAL DIPOLE ANTENNA, filed Feb. 26, 2013, the disclosure of which is hereby incorporated by reference and priority of which is hereby claimed pursuant to 37 CFR 1.78(a)(4) and (5)(i).

### FIELD OF THE INVENTION

The present invention relates generally to antennas and more particularly to dipole antennas.

### BACKGROUND OF THE INVENTION

Various types of dipole antennas are known in the art.

### SUMMARY OF THE INVENTION

The present invention seeks to provide a wideband dual-polarized dipole antenna and a coupling element therefore.

There is thus provided in accordance with a preferred embodiment of the present invention a dual-polarized dipole antenna including a first pair of dipole arms resonating in a first frequency band, a second pair of dipole arms intersecting the first pair of dipole arms and arranged orthogonally with respect to the first pair of dipole arms, the second pair of dipole arms resonating in the first frequency band and at least one conductive cruciform element mounted on the first and second pairs of dipole arms and resonating in a second frequency band.

Preferably, the antenna also includes a first feed for feeding the first pair of dipole arms and a second feed for feeding the second pair of dipole arms.

Preferably, the first and second feeds include coaxial cables.

Alternatively, the first and second feeds include microstrip feedlines.

Preferably, the at least one conductive cruciform element is galvanically isolated from the first and second pairs of dipole arms.

Preferably, the at least one conductive cruciform element is capacitively coupled to the first and second pairs of dipole arms.

Preferably, the at least one conductive cruciform element is separated from the first and second pairs of dipole arms by an electrical distance of less than λ, wherein λ is a wavelength corresponding to the first frequency band.

Preferably, the at least one conductive cruciform element is separated from the first and second pairs of dipole arms by an electrical distance of less than 0.03λ.

Preferably, the at least one cruciform conductive element includes a first conductive strip orthogonally intersected by a second conductive strip.

Preferably, each one of the first and second conductive strips has an electrical length of less than λ/2, wherein λ is a wavelength corresponding to the first frequency band.

Preferably, the at least one conductive cruciform element includes two conductive cruciform elements.

Preferably, the antenna also includes a first balun portion and a second balun portion.

In accordance with a preferred embodiment of the present invention, the first and second pairs of dipole arms and the first and second balun portions are formed by a single metallic template.

Preferably, the single metallic template includes a single sheet of metal.

In accordance with another preferred embodiment of the present invention, the first and second balun portions are formed by a single metallic template.

Preferably, the single metallic template includes a single sheet of metal.

Preferably, the first and second pairs of dipole arms are disposed on a non-conductive substrate.

Preferably, the non-conductive substrate includes a printed circuit board substrate.

Preferably, the first and second conductive strips are vertically aligned with respect to the first and second pairs of dipole arms.

Alternatively, the first and second conductive strips are vertically non-aligned with respect to the first and second pairs of dipole arms.

### BRIEF DESCRIPTION OF THE DRAWINGS

The present invention will be understood and appreciated more fully from the following detailed description, taken in conjunction with the drawings in which:

FIGS. 1A, 1B and 1C are simplified respective assembled, exploded and side view illustrations of a dipole antenna constructed and operative in accordance with a preferred embodiment of the present invention;

FIGS. 2A, 2B and 2C are simplified respective assembled, exploded and side view illustrations of a dipole antenna constructed and operative in accordance with another preferred embodiment of the present invention;

FIG. 3 is a simplified perspective view illustration of a dipole antenna constructed and operative in accordance with yet another preferred embodiment of the present invention;

FIG. 4 is a simplified illustration of a template for forming a dipole antenna of the types shown in FIGS. 1A-3;

FIGS. 5A, 5B and 5C are simplified respective assembled, exploded and side view illustrations of a dipole antenna constructed and operative in accordance with still another preferred embodiment of the present invention; and

FIGS. 6A, 6B and 6C are simplified respective assembled, exploded and side view illustrations of a dipole antenna constructed and operative in accordance with a still further preferred embodiment of the present invention.

### DETAILED DESCRIPTION OF PREFERRED EMBODIMENTS

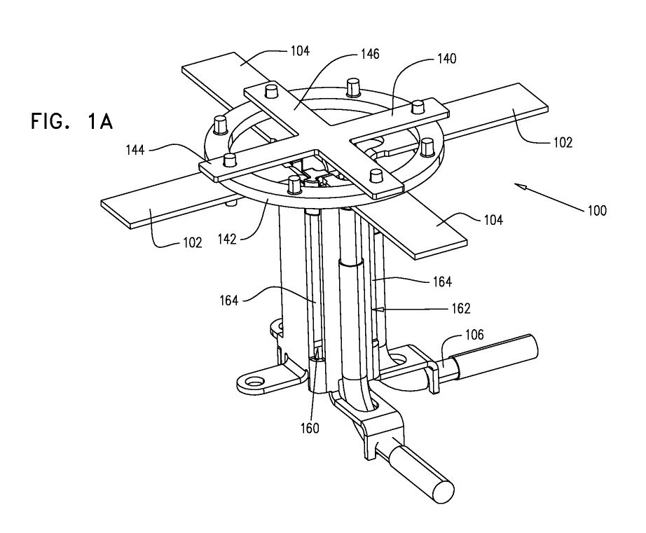

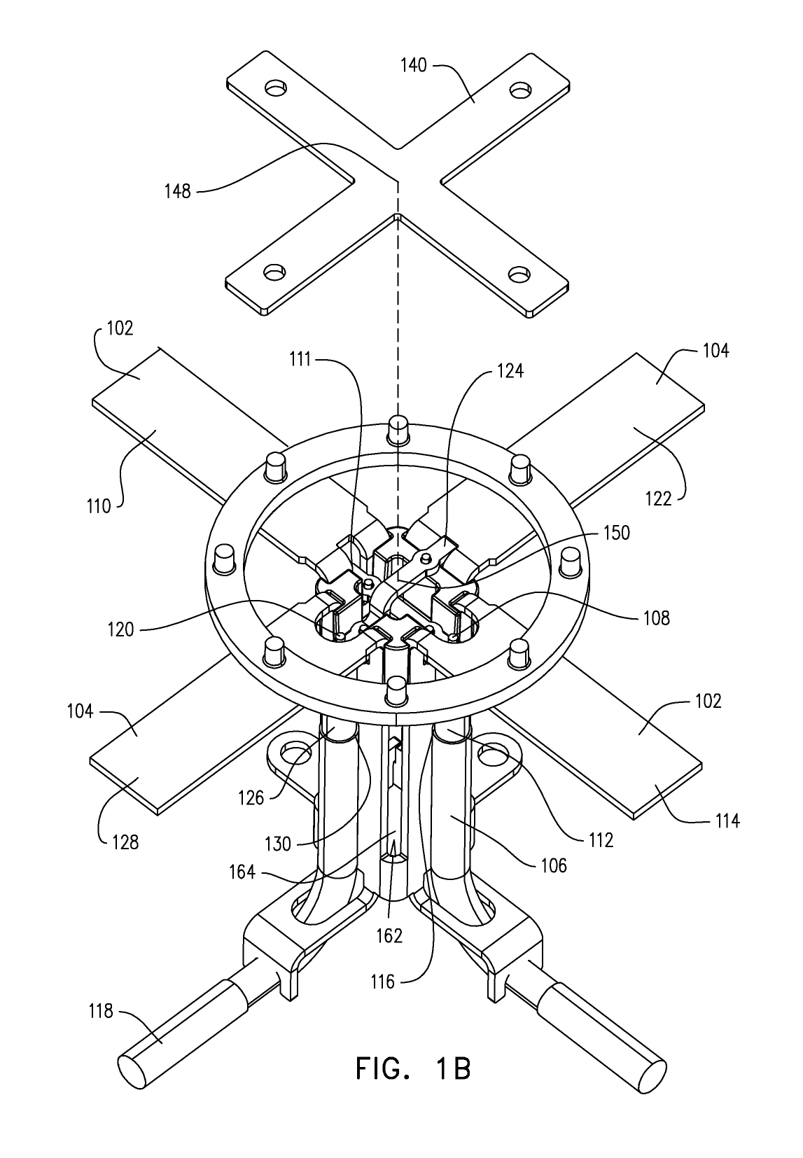

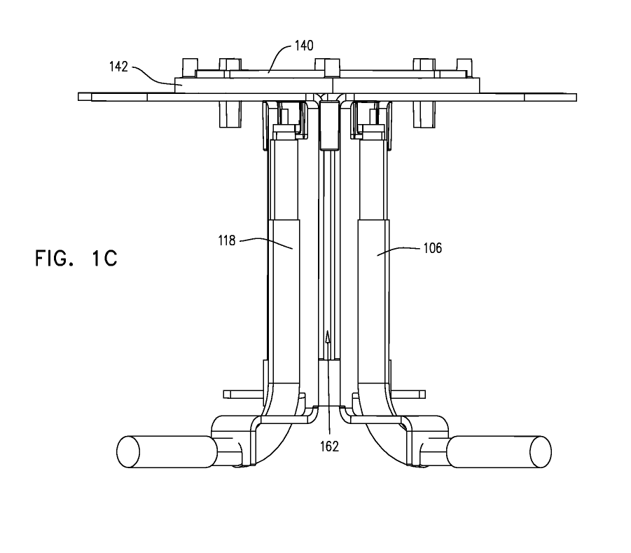

Reference is now made to FIGS. 1A-1C, which are simplified respective assembled, exploded and side view illustrations of a dipole antenna constructed and operative in accordance with a preferred embodiment of the present invention.

As seen in FIGS. 1A-1C, there is provided a dual-polarized dipole antenna 100 preferably including a first pair of dipole arms 102 and a second pair of dipoles arms 104 preferably intersecting the first pair of dipole arms 102 and orthogonally arranged with respect thereto. First pair of dipole arms 102 preferably radiates with a first polarization in a first frequency band. Second pair of dipole arms 104 preferably radiates in the first frequency band with a second polarization, orthogonal to the first polarization of first pair of dipole arms 102. The first and second respective polarizations of first and second pairs of dipole arms 102 and 104 are preferably slanted ±45°, resulting in dipole antenna 100 having a unidirectional, dual-polarized radiation pattern.

First pair of dipole arms 102 is preferably fed by a first feed 106, here embodied, by way of example, as a first coaxial cable 106. An inner conductor 108 of first coaxial cable 106 is preferably galvanically connected to one arm 110 of first pair of dipole arms 102 at a first feed point 111, as seen most clearly in FIG. 1B. An outer conductive sheath 112 of first coaxial cable 106 is preferably galvanically connected to an extension of another arm 114 of first pair of dipole arms 102 at a first grounding region 116.

Second pair of dipole arms 104 is preferably fed by way of a second feed 118, here embodied, by way of example, as a second coaxial cable 118. An inner conductor 120 of second coaxial cable 118 is preferably galvanically connected to one arm 122 of second pair of dipole arms 104 at a second feed point 124, as seen most clearly in FIG. 1B. An outer conductive sheath 126 of second coaxial cable 118 is preferably galvanically connected to an extension of another arm 128 of second pair of dipole arms 104 at a second grounding region 130.

It is appreciated that as a result of the above-described respective feed arrangements of first and second pairs of dipole arms 102 and 104, one arm 110, 122 of each one of first and second pairs of dipole arms 102, 104 is preferably fed and the other arm 114, 128 of each one of first and second pairs of dipole arms 102, 104 is preferably grounded and therefore preferably acts as a counterpoise arm.

It is a particular feature of a preferred embodiment of the present invention that dual-polarized dipole antenna 100 further preferably includes at least one conductive cruciform element mounted on first and second pairs of dipole arms 102 and 104, here embodied, by way of example, as a conductive cruciform element 140 non-galvanically mounted upon first and second pairs of dipole arms 102 and 104 by way of a non-conductive ring-shaped mounting element 142. Cruciform conductive element 140 is preferably capacitively coupled to first and second pairs of dipole arms 102 and 104 and is preferably vertically offset therefrom by a distance much smaller than λ, wherein λ is a wavelength corresponding to the first frequency band of operation of dual-polarized dipole antenna 100. By way of example, only, cruciform conductive element 140 may be vertically offset from first and second pairs of dipole arms 102 and 104 by an electrical distance of less than 0.03λ, preferably corresponding to a physical distance of less than approximately 5 mm.

Cruciform element 140 is preferably capacitively fed by way of first and second pairs of dipole arms 102 and 104 and preferably resonates in a second frequency band, which second frequency band preferably spans a higher frequency range than that of the first frequency band of radiation of first and second pairs of dipole arms 102 and 104. The second frequency band of radiation, arising from cruciform element 140, in combination with the first frequency band of radiation, arising from first and second pairs of dipole arms 102 and 104, preferably forms a combined broad frequency band of radiation of dual-polarized dipole antenna 100. It is understood that cruciform element 140 thus functions to advantageously broaden the frequency band of radiation of dual-polarized dipole antenna in both of the polarizations of radiation thereof.

Dipole antenna 100, including cruciform element 140, may operate over a very broad frequency range spanning approximately 1710-2700 MHz. It is appreciated that multiple ones of dipole antenna 100 may be arranged in an array configuration, thus creating a dual-polarized broadband antenna array.

Cruciform element 140 preferably comprises a first conductive strip 144 and a second conductive strip 146 preferably orthogonally intersecting therewith. It is appreciated that cruciform element 140 is preferably formed as a monolithic element and that the demarcation of first and second strips 144 and 146 is for reference purposes only. It is further appreciated that first and second conductive strips 144 and 146 may be mutually symmetrical, as seen in FIGS. 1A and 1B, or may alternatively be mutually asymmetrical.

As seen most clearly in FIG. 1B a point of intersection 148 of first and second conductive strips 144 and 146 is preferably co-linear with a point of intersection 150 of first and second pairs of dipole arms 102 and 104. It is appreciated that cruciform element 140 preferably has a geometry generally similar to the geometry of first and second pairs of dipole arms 102 and 104. However, the shape of cruciform element 140 is preferably not congruent with that of first and second pairs of dipole arms 102 and 104 due to the smaller physical and electrical length of cruciform element 140.

An electrical length of each one of first and second pairs of dipole arms 102 and 104, as measured from a first tip of one of dipole arms 110, 122 to a second tip of the corresponding other dipole arm 114, 128 of each one of dipole pairs 102 and 104, is preferably generally equal to λ/2. It is appreciated that first and second pairs of dipole arms 102 and 104 may be mutually symmetrical, as illustrated in FIGS. 1A and 1B, or may alternatively be mutually asymmetrical.

An electrical length of each one of first and second conductive strips 144 and 146 is preferably less than λ/2. As a result of the smaller electrical length of each one of the conductive strips 144, 146 forming cruciform element 140, in comparison to the electrical length of each one of first and second pairs of dipole arms 102, 104, cruciform element 140 preferably resonates in a higher frequency band than that of first and second pairs of dipole arms 102, 104, thereby giving rise to the above-described band widening effect.

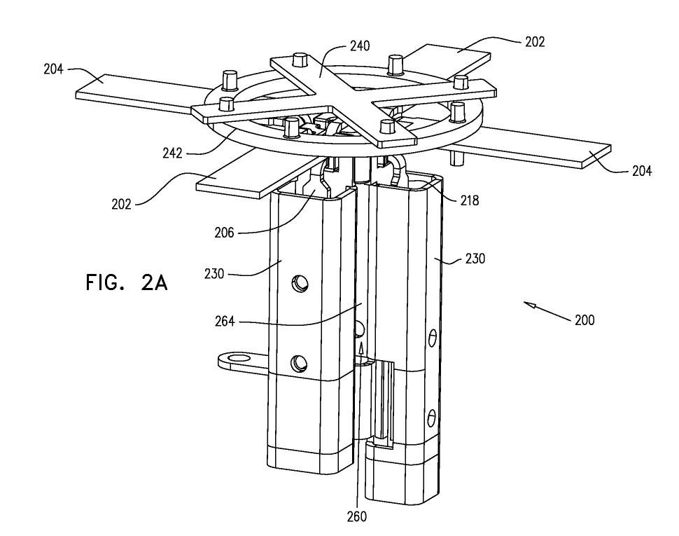

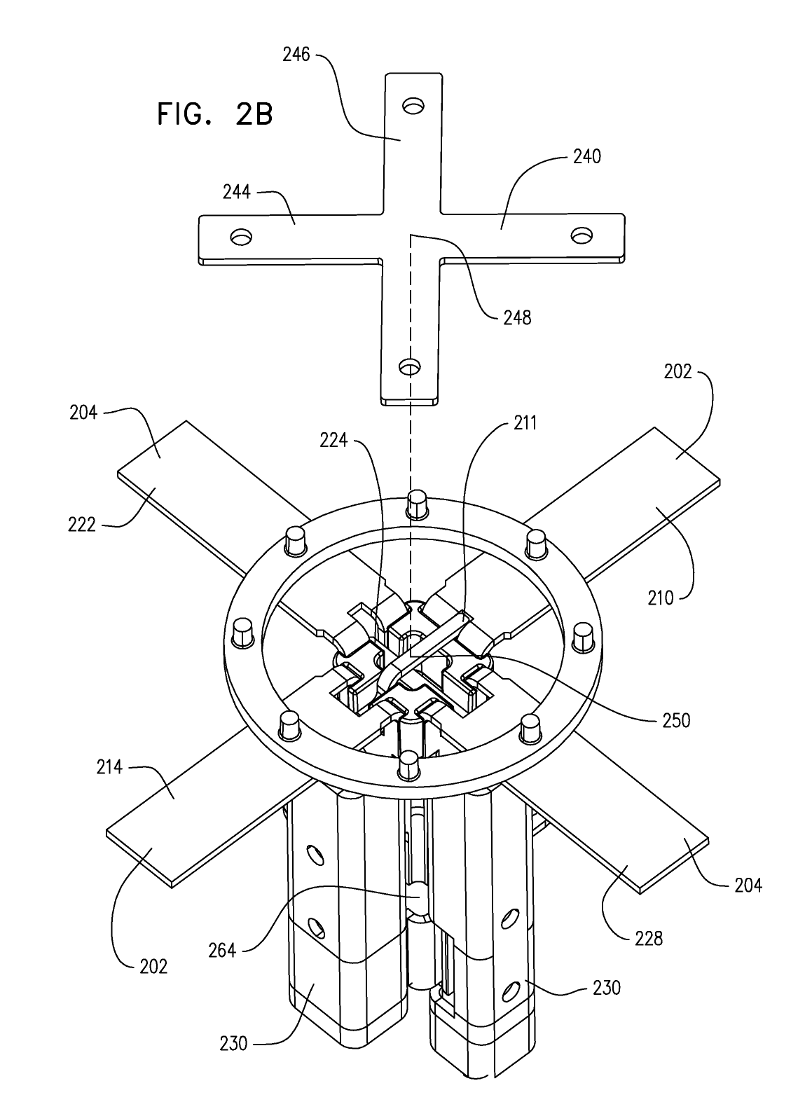

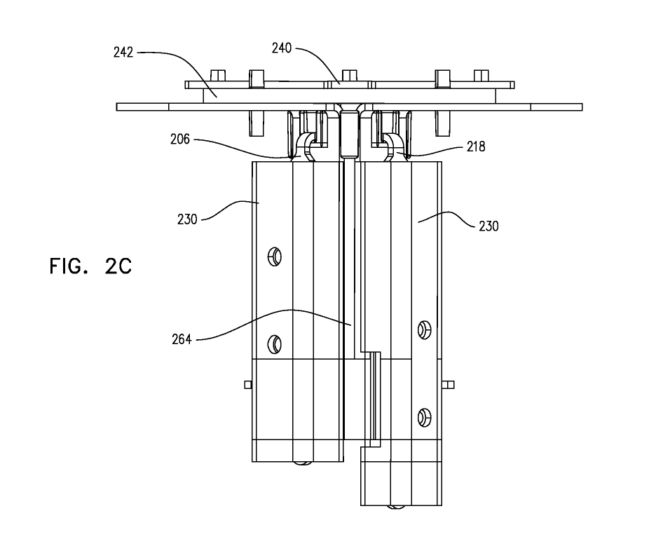

First and second conductive strips 144 and 146 may be vertically aligned with first and second pairs of dipole arms 102 and 104, as illustrated in dual-polarized dipole antenna 100. However, it is appreciated that first and second conductive strips 144 and 146 of cruciform element 140 may alternatively be rotated about point of intersection 148 so as to be vertically non-aligned with first and second pairs of dipole arms 102 and 104, as will be exemplified henceforth with reference to FIGS. 2A-2C.

It is an additional particular feature of a preferred embodiment of the present invention that dual-polarized dipole antenna 100 further preferably includes a first and a second vertical balun portion 160 and 162, preferably integrally formed within the body of antenna 100. Each one of grounded dipole arms 114 and 128 is preferably respectively connected to first and second vertical balun portions 160 and 162. Vertical balun portions 160 and 162 preferably each comprise a slotted portion 164 preferably having an electrical length generally equal to λ/4, wherein λ is a wavelength corresponding to the first frequency band of radiation of first and second pairs of dipole arms 102 and 104.

The integral formation of vertical balun portions 160 and 162 within dual-polarized dipole antenna 100 serves to advantageously simplify the feeding arrangement employed therein. This is in contrast to conventional dual-polarized dipole antennas, which antennas typically require complex feed networks formed separately from the body of the antenna. As a result of the grounding of one dipole arm 114, 128 of each pair of dipole arms 102 and 104 by way of vertical balun portions 160 and 162, each one of pair of dipole arms 102 and 104 is preferably directly grounded and is therefore particularly well-suited for use in electrically challenging environments, such as outdoors.

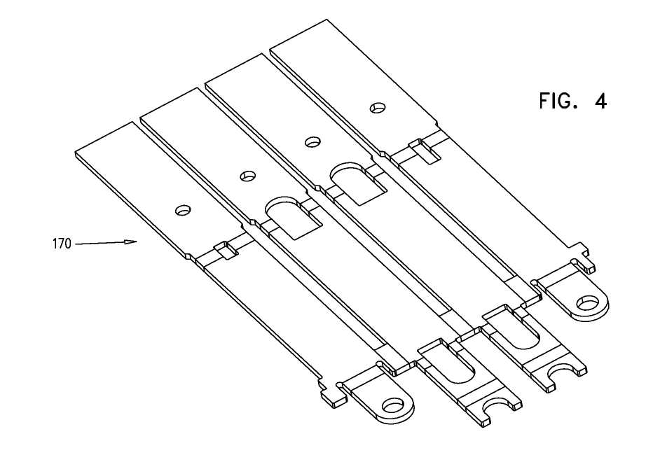

Dual-polarized dipole antenna 100 may be formed by a single bent metal template, such as a metal template 170 illustrated in FIG. 4. Metal template 170 particularly preferably comprises sheet metal and may be formed by stamping in a stamping machine. Metal sheet 170 is preferably folded so as to form antenna 100. The preferable formation of dual-polarized dipole antenna 100 by a single metal sheet 170 results in dual-polarized dipole antenna 100 being particularly economical and simple to assemble and thus extremely well-suited for mass-production. Furthermore, due to the entirety of the body of dual-polarized dipole antenna 100 being formed by a single piece of metal, with the exception of cruciform element 140, antenna 100 is preferably able to withstand extreme operating conditions, including high power and high temperature conditions. Additionally, the integral formation of first and second balun portions 160 and 162 by portions of metal sheet 170 simplifies the feed arrangement of antenna 100 and minimizes the number of parts required therein, thereby further reducing the costs of manufacturing antenna 100.

Reference is now made to FIGS. 2A-2C, which are simplified respective assembled, exploded and side view illustrations of a dipole antenna constructed and operative in accordance with another preferred embodiment of the present invention.

As seen in FIGS. 2A-2C, there is provided a dual-polarized dipole antenna 200 preferably including a first pair of dipole arms 202 and a second pair of dipoles arms 204 preferably intersecting the first pair of dipole arms 202 and orthogonally arranged with respect thereto. First pair of dipole arms 202 preferably radiates with a first polarization in a first frequency band. Second pair of dipole arms 204 preferably radiates in the first frequency band with a second polarization, orthogonal to the first polarization of first pair of dipole arms 202. The first and second respective polarizations of first and second pairs of dipole arms 202 and 204 are preferably slanted ±45°, resulting in dipole antenna 200 having a unidirectional, dual-polarized radiation pattern.

First pair of dipole arms 202 is preferably fed by a first feed 206, here embodied, by way of example, as a first microstrip feedline 206 preferably galvanically connected to one arm 210 of first pair of dipole arms 202 at a first feed point 211, as seen most clearly in FIG. 2B. Another arm 214 of first pair of dipole arms 202 is preferably connected to a grounding element (not shown), on which grounding element dipole antenna 200 is preferably disposed.

Second pair of dipole arms 204 is preferably fed by way of a second feed 218, here embodied, by way of example, as a second microstrip feedline 218 preferably galvanically connected to one arm 222 of second pair of dipole arms 204 at a second feed point 224, as seen most clearly in FIG. 2B. Another arm 228 of second pair of dipole arms 204 is preferably connected to the grounding element (not shown) upon which dipole antenna 200 is preferably disposed.

Each one of first and second microstrip feedlines 206 and 218 may be enclosed by a metal enclosure 230, which metal enclosure 230 serves to improve the cross-polarization of the ±45° polarizations of first and second pairs of dipole arms 202 and 204.

It is appreciated that as a result of the above-described respective feed arrangements of first and second pairs of dipole arms 202 and 204, one arm 210, 222 of each one of first and second pairs of dipole arms 202, 204 is preferably fed and the other arm 214, 228 of each one of first and second pairs of dipole arms 202, 204 is preferably grounded and therefore preferably acts as a counterpoise arm.

It is a particular feature of a preferred embodiment of the present invention that dual-polarized dipole antenna 200 further preferably includes at least one conductive cruciform element mounted on first and second pairs of dipole arms 202, 204, here embodied, by way of example, as a conductive cruciform element 240 non-galvanically mounted upon first and second pairs of dipole arms 202 and 204 by way of a non-conductive ring-shaped mounting element 242. Cruciform conductive element 240 is preferably capacitively coupled to first and second pairs of dipole arms 202 and 204 and is preferably vertically offset therefrom by a distance much smaller than λ, wherein λ is a wavelength corresponding to the first frequency band of operation of dipole antenna 200. By way of example, only, cruciform conductive element 240 may be vertically offset from first and second pairs of dipole arms 202 and 204 by a distance of less than 0.03λ, preferably corresponding to a physical distance of less than approximately 5 mm.

Cruciform element 240 is preferably capacitively fed by way of first and second pairs of dipole arms 202 and 204 and preferably resonates in a second frequency band, which second frequency band preferably spans a higher frequency range than that of the first frequency band of radiation of first and second pairs of dipole arms 202 and 204. The second frequency band of radiation, arising from cruciform element 240, in combination with the first frequency band of radiation, arising from first and second pairs of dipole arms 202 and 204, forms a combined broad frequency band of radiation of dual-polarized dipole antenna 200. It is understood that cruciform element 240 thus functions to advantageously broaden the frequency band of radiation of dual-polarized dipole antenna 200 in both of the polarizations of radiation thereof. Dipole antenna 200, including cruciform element 240, may operate over a very broad frequency range spanning approximately 1710-2700 MHz. It is appreciated that multiple ones of dipole antenna 200 may be arranged in an array configuration, thus creating a dual-polarized broadband antenna array.

Cruciform element 240 preferably comprises a first conductive strip 244 and a second conductive strip 246 orthogonally intersecting therewith. It is appreciated that cruciform element 240 is preferably formed as a monolithic element and that the demarcation of first and second strips 244 and 246 is for reference purposes only. It is further appreciated that first and second conductive strips 244 and 246 may be mutually symmetrical, as seen in FIGS. 2A and 2B, or may alternatively be mutually asymmetrical.

As seen most clearly in FIG. 2B a point of intersection 248 of first and second conductive strips 244 and 246 is preferably co-linear with a point of intersection 250 of first and second pairs of dipole arms 202 and 204. It is appreciated that cruciform element 240 preferably has a geometry similar to the geometry of first and second pairs of dipole arms 202 and 204. However, the shape of cruciform element 240 is preferably not congruent with that of first and second pairs of dipole arms 202 and 204 due to the smaller physical and electrical length of cruciform element 240.

An electrical length of each one of first and second pairs of dipole arms 202 and 204, as measured from a first tip of one of dipole arms 210, 222 to a second tip of the corresponding other dipole arm 214, 228 of each one of dipole pairs 202 and 204, is preferably generally equal to λ/2. It is appreciated that first and second pairs of dipole arms 202 and 204 may be mutually symmetrical, as illustrated in FIGS. 2A and 2B, or may alternatively be mutually asymmetrical.

An electrical length of each one of first and second conductive strips 244 and 246 is preferably less than λ/2. As a result of the smaller electrical length of each one of the conductive strips 244, 246 forming cruciform element 240, in comparison to the electrical length of each one of first and second pairs of dipole arms 202, 204, cruciform element 240 preferably resonates in a higher frequency band than that of first and second pairs of dipole arms 202, 204, thereby giving rise to the above-described band widening effect.

First and second conductive strips 244 and 246 may be vertically non-aligned with respect to first and second pairs of dipole arms 202 and 204, such that a projection of first and second conductive strips 244 and 246 onto the plane of first and second pairs of dipole arms 202 and 204 is offset from first and second pairs of dipole arms 202 and 204 by an angle of approximately 45°. It is appreciated, however, that first and second conductive strips 244 and 246 forming cruciform element 240 may be angularly offset from first and second pairs of dipole arms 202 and 204 by angles other than 45°.

It is an additional particular feature of a preferred embodiment of the present invention that dual-polarized dipole antenna 200 further preferably includes a first vertical balun portion 260 and a second vertical balun portion (not shown), preferably integrally formed within the body of antenna 200. Each one of grounded dipole arms 214 and 228 is preferably respectively connected to first and second vertical balun portions. The first and second vertical balun portions preferably each comprise a slotted portion 264 preferably having an electrical length generally equal to λ/4, wherein λ is a wavelength corresponding to the first frequency band of radiation of first and second pairs of dipole arms 202 and 204.

The integral formation of vertical balun portions within dual-polarized dipole antenna 200 serves to advantageously simplify the feeding arrangement employed therein. This is in contrast to conventional dual-polarized dipole antennas, which antennas typically require complex feed networks formed separately from the body of the antenna. As a result of the grounding of one dipole arm 214, 228 of each pair of dipole arms 202 and 204 by way of vertical balun portions, each one of pair of dipole arms 202 and 204 is preferably directly grounded and is therefore particularly well-suited for use in electrically challenging environments, such as outdoors.

Dual-polarized dipole antenna 200 may be formed by a single bent metal template, such as metal template 170 illustrated in FIG. 4. The preferable formation of dual-polarized dipole antenna 200 by a single metal sheet results in dual-polarized dipole antenna 200 being particularly economical and simple to assemble and thus extremely well-suited for mass-production. Furthermore, due to the entirety of the body of dual-polarized dipole antenna 200 being formed by a single piece of metal, with the exception of cruciform element 240, antenna 200 is preferably able to withstand extreme operating conditions, including high power and high temperature conditions. Additionally, the integral formation of first and second balun portions by portions of a metal sheet simplifies the feed arrangement of antenna 200 and minimizes the number of parts required therein, thereby further reducing the costs of manufacturing antenna 200.

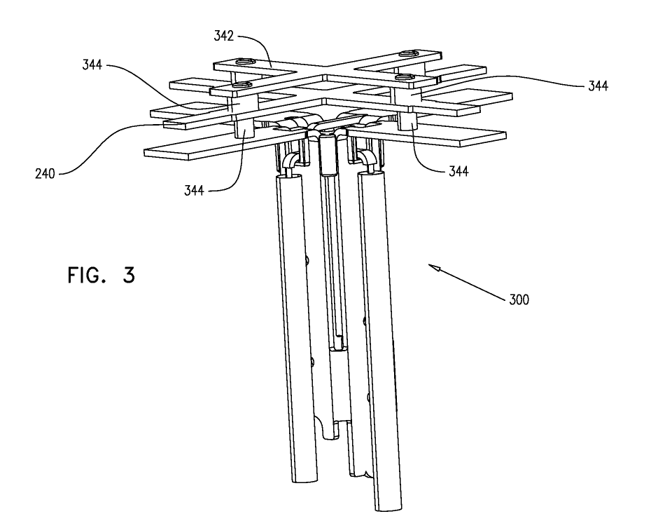

It is appreciated that although dipole antenna 200 is shown in FIGS. 2A-2C to include only a single cruciform element 240, dipole antenna 200 may alternatively include more than one cruciform element 240, as seen in the case of dipole antenna 300, shown in FIG. 3, which preferably includes a second cruciform element 342 non-galvanically mounted on cruciform element 240 by way of a multiplicity of non-conductive posts 344. It is appreciated that the inclusion of more than one cruciform element in the antennas of the present invention serves to further advantageously widen the bandwidth of operation of the antennas.

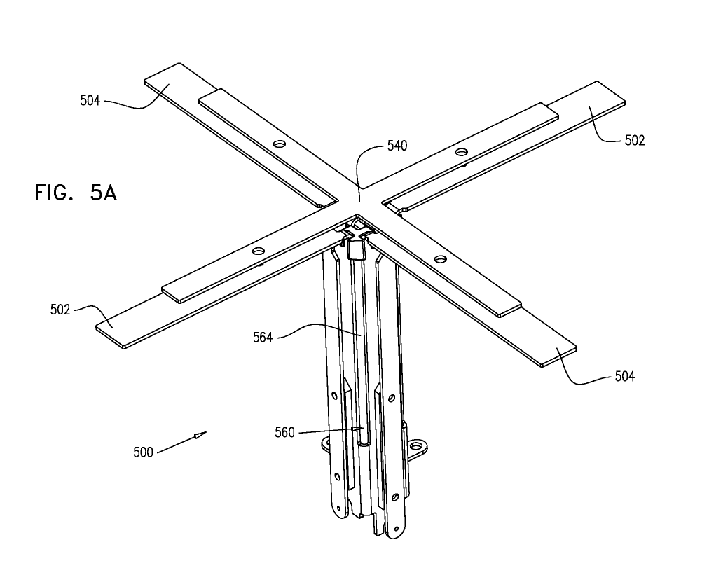

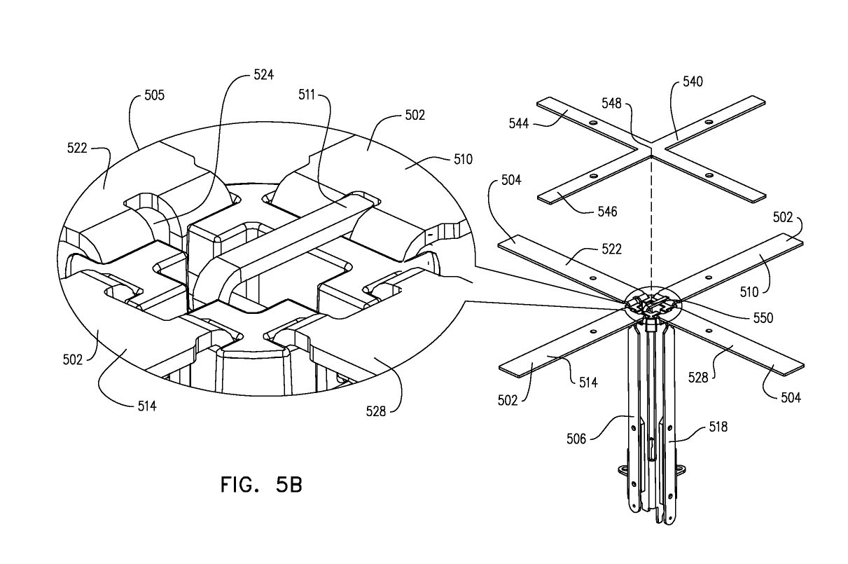

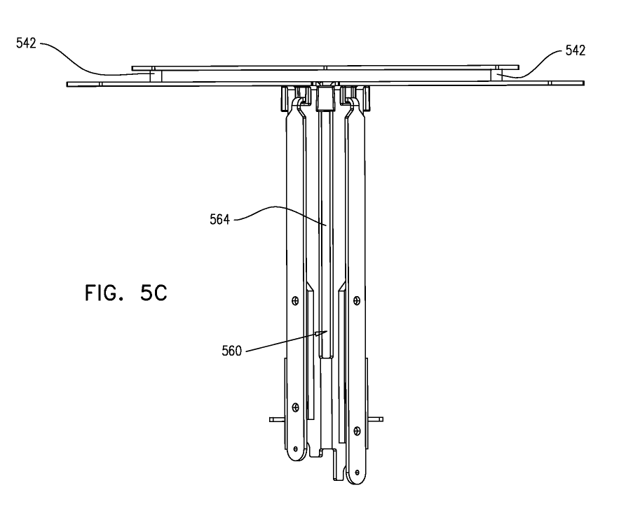

Reference is now made to FIGS. 5A, 5B and 5C, which are simplified respective assembled, exploded and side view illustrations of a dipole antenna constructed and operative in accordance with still another preferred embodiment of the present invention.

As seen in FIGS. 5A-5C, there is provided a dual-polarized dipole antenna 500 preferably including a first pair of dipole arms 502 and a second pair of dipoles arms 504 preferably intersecting the first pair of dipole arms 502 and orthogonally arranged with respect thereto. First pair of dipole arms 502 preferably radiates with a first polarization in a first frequency band. Second pair of dipole arms 504 preferably radiates in the first frequency band with a second polarization, orthogonal to the first polarization of first pair of dipole arms 502. The first and second respective polarizations of first and second pairs of dipole arms 502 and 504 are preferably slanted ±45°, resulting in dipole antenna 500 having a unidirectional, dual-polarized radiation pattern.

As seen most clearly at an enlargement 505 in FIG. 5B, first pair of dipole arms 502 is preferably fed by a first feed 506, here embodied, by way of example, as a first microstrip feedline 506 preferably galvanically connected to one arm 510 of first pair of dipole arms 502 at a first feed point 511. Another arm 514 of first pair of dipole arms 502 is preferably connected to a grounding element (not shown), on which grounding element dipole antenna 500 is preferably disposed.

Second pair of dipole arms 504 is preferably fed by way of a second feed 518, here embodied, by way of example, as a second microstrip feedline 518 preferably galvanically connected to one arm 522 of second pair of dipole arms 504 at a second feed point 524, as seen most clearly in FIG. 5B. Another arm 528 of second pair of dipole arms 504 is preferably connected to the grounding element (not shown) upon which dipole antenna 500 is preferably disposed.

Each one of first and second microstrip feedlines 506 and 518 may optionally be enclosed by a metal enclosure (not shown) which metal enclosure serves to improve the cross-polarization of ±45° polarizations of first and second pairs of dipole arms 502 and 504.

It is appreciated that as a result of the above-described respective feed arrangements of first and second pairs of dipole arms 502 and 504, one arm 510, 522 of each one of first and second pairs of dipole arms 502, 504 is preferably fed and the other arm 514, 528 of each one of first and second pairs of dipole arms 502, 504 is preferably grounded and therefore preferably acts as a counterpoise arm.

It is a particular feature of a preferred embodiment of the present invention that dual-polarized dipole antenna 500 further preferably includes at least one conductive cruciform element mounted on first and second pairs of dipole arms 502, 504, here embodied, by way of example, as a conductive cruciform element 540 non-galvanically mounted upon first and second pairs of dipole arms 502 and 504 by way of a multiplicity of non-conductive posts 542. It is appreciated that although dipole antenna 500 is illustrated in FIGS. 5A-5C as including only a single cruciform element 540, dipole antenna 500 may alternatively include more than one cruciform element 540, in order to further advantageously widen the bandwidth of operation of dipole antenna 500.

Cruciform conductive element 540 is preferably capacitively coupled to first and second pairs of dipole arms 502 and 504 and is preferably vertically offset therefrom by a distance much smaller than λ, wherein λ is a wavelength corresponding to the first frequency band of operation of dipole antenna 500. By way of example, only, cruciform conductive element 540 may be vertically offset from first and second pairs of dipole arms 502 and 504 by a distance of less than 0.03λ, preferably corresponding to a physical distance of less than approximately 5 mm.

Cruciform element 540 is preferably capacitively fed by way of first and second pairs of dipole arms 502 and 504 and preferably resonates in a second frequency band, which second frequency band preferably spans a higher frequency range than that of the first frequency band of radiation of first and second pairs of dipole arms 502 and 504. The second frequency band of radiation, arising from cruciform element 540, in combination with the first frequency band of radiation, arising from first and second pairs of dipole arms 502 and 504, preferably forms a combined broad frequency band of radiation of dual-polarized dipole antenna 500. It is understood that cruciform element 540 thus functions to advantageously broaden the frequency band of radiation of dual-polarized dipole antenna 500 in both of the polarizations of radiation thereof.

As will be appreciated from a comparison of dipole antenna 500 to dipole antenna 200, dipole antenna 500 is preferably larger, both in its vertical and horizontal extent, than dipole antenna 200. As a result, dipole antenna 500, including cruciform element 540, may operate over a very broad frequency range spanning approximately 700-960 MHz, which frequency range is preferably lower than that of somewhat comparable dipole antenna 200, due to the differences in dimensions therebetween. It is appreciated that multiple ones of dipole antenna 500 may be arranged in an array configuration, thus creating a dual-polarized low frequency broadband antenna array.

Cruciform element 540 preferably comprises a first conductive strip 544 and a second conductive strip 546 preferably orthogonally intersecting therewith. It is appreciated, that cruciform element 540 is preferably formed as a monolithic element and that the demarcation of first and second strips 544 and 546 is for reference purposes only. It is further appreciated that first and second conductive strips 544 and 546 may be mutually symmetrical, as seen in FIGS. 5A and 5B, or may alternatively be mutually asymmetrical.

As seen most clearly in FIG. 5B a point of intersection 548 of first and second conductive strips 544 and 546 is preferably co-linear with a point of intersection 550 of first and second pairs of dipole arms 502 and 504. It is appreciated that cruciform element 540 preferably has a geometry similar to the geometry of first and second pairs of dipole arms 502 and 504. However, the shape of cruciform element 540 is preferably not congruent with that of first and second pairs of dipole arms 502 and 504 due to the smaller physical and electrical length of cruciform element 540.

An electrical length of each one of first and second pairs of dipole arms 502 and 504, as measured from a first tip of one of dipole arms 510, 522 to a second tip of the corresponding other dipole arm 514, 528 of each one of dipole pairs 502 and 504, is preferably generally equal to λ/2. It is appreciated that first and second pairs of dipole arms 502 and 504 may be mutually symmetrical, as illustrated in FIGS. 5A and 5B, or may alternatively be mutually asymmetrical.

An electrical length of each one of first and second conductive strips 544 and 546 is preferably less than λ/2. As a result of the smaller electrical length of each one of the conductive strips 544, 546 forming cruciform element 540, in comparison to the electrical length of each one of first and second pairs of dipole arms 502, 504, cruciform element 540 preferably resonates in a higher frequency band than that of first and second pairs of dipole arms 502, 504, thereby giving rise to the above-described band widening effect.

First and second conductive strips 544 and 546 may be vertically aligned with first and second pairs of dipole arms 502 and 504, such that a projection of first and second conductive strips 544 and 546 onto the plane of first and second pairs of dipole arms 502 and 504 overlaps with first and second pairs of dipole arms 502 and 504. It is appreciated, however, that first and second conductive strips 544 and 546 forming cruciform element 540 may alternatively be vertically non-aligned with respect to first and second pairs of dipole arms 502 and 504, such that a projection of conductive strips 544 and 546 onto the plane of first and second pairs of dipole arms 502 and 504 is angularly offset from first and second pairs of dipole arms 502 and 504.

It is an additional particular feature of a preferred embodiment of the present invention that dual-polarized dipole antenna 500 further preferably includes a first vertical balun portion 560 and a second vertical balun portion (not shown), preferably integrally formed within the body of antenna 500. Each one of grounded dipole arms 514 and 528 is preferably respectively connected to first and second vertical balun portions. First and second vertical balun portions preferably each comprise a slotted portion 564 preferably having an electrical length generally equal to λ/4, wherein λ is a wavelength corresponding to the first frequency band of radiation of first and second pairs of dipole arms 502 and 504.

The integral formation of first and second vertical balun portions within dual-polarized dipole antenna 500 serves to advantageously simplify the feeding arrangement employed therein. This is in contrast to conventional dual-polarized dipole antennas, which antennas typically require complex feed networks formed separately from the body of the antenna. As a result of the grounding of one dipole arm 514, 528 of each pair of dipole arms 502 and 504 by way of vertical balun portions, each one of pair of dipole arms 502 and 504 is preferably directly grounded and is therefore particularly well-suited for use in electrically challenging environments, such as outdoors.

Dual-polarized dipole antenna 500 may be formed by a single bent metal sheet, generally resembling metal sheet 170 illustrated in FIG. 4 but having different dimensions thereto. The preferable formation of dual-polarized dipole antenna 500 by a single metal sheet results in dual-polarized dipole antenna 500 being particularly economical and simple to assemble and thus extremely well-suited for mass-production. Furthermore, due to the entirety of the body of dual-polarized dipole antenna 500 being formed by a single piece of metal, with the exception of cruciform element 540, antenna 500 is preferably able to withstand extreme operating conditions, including high power and high temperature conditions. Additionally, the integral formation of first and second balun portions by portions of a metal sheet simplifies the feed arrangement of antenna 500 and minimizes the number of parts required therein, thereby further reducing the costs of manufacturing antenna 500.

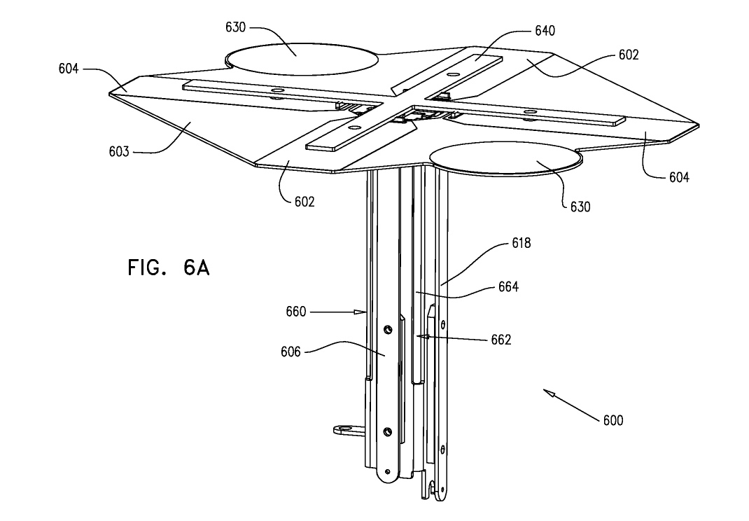

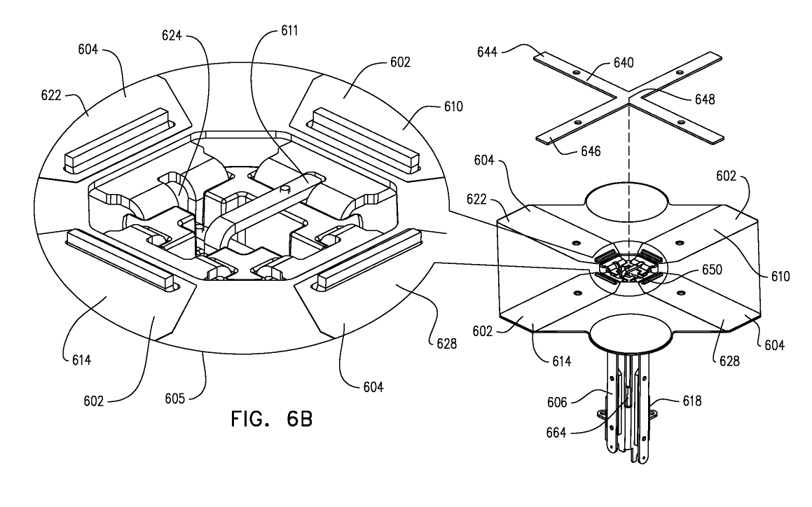

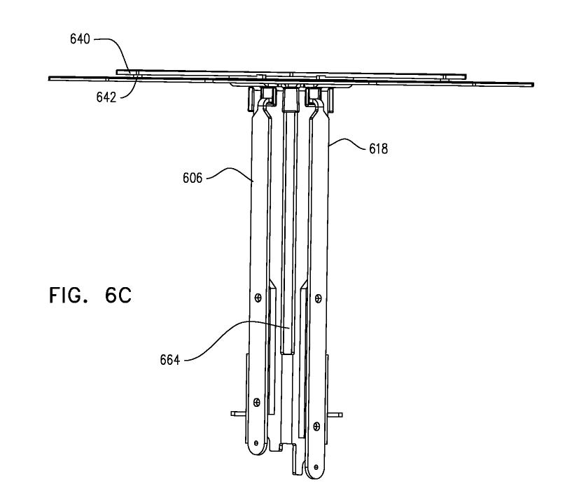

Reference is now made to FIGS. 6A-6C, which are simplified respective assembled, exploded and side view illustrations of a dipole antenna constructed and operative in accordance with a still further preferred embodiment of the present invention.

As seen in FIGS. 6A-6C, there is provided a dual-polarized dipole antenna 600 preferably including a first pair of dipole arms 602 and a second pair of dipoles arms 604 preferably intersecting the first pair of dipole arms 602 and orthogonally arranged with respect thereto. First and second pairs of dipole arms 602 and 604 are preferably disposed on a surface of a non-conductive substrate 603. Substrate 603 may comprise a printed circuit board (PCB) substrate on which PCB first and second pairs of dipole arms 602 and 604 may be printed, plated or otherwise formed.

First and second pairs of dipole arms 602 and 604 preferably each radiate in a first frequency band. First pair of dipole arms 602 preferably has a first polarization of radiation and second pair of dipole arms 604 preferably has a second polarization of radiation, orthogonal to the first polarization of first pair of dipole arms 602. The first and second respective polarizations of first and second pairs of dipole arms 602 and 604 are preferably slanted ±45°, resulting in dipole antenna 600 having a unidirectional, dual-polarized radiation pattern.

As seen most clearly at an enlargement 605 in FIG. 6B, first pair of dipole arms 602 is preferably fed by a first feed 606, here embodied, by way of example, as a first microstrip feedline 606 preferably galvanically connected to one arm 610 of first pair of dipole arms 602 at a first feed point 611. Another arm 614 of first pair of dipole arms 602 is preferably connected to a grounding element (not shown), on which grounding element dipole antenna 600 is preferably disposed.

Second pair of dipole arms 604 is preferably fed by way of a second feed 618, here embodied, by way of example, as a second microstrip feedline 618 preferably galvanically connected to one arm 622 of second pair of dipole arms 604 at a second feed point 624, as seen most clearly in FIG. 6B. Another arm 628 of second pair of dipole arms 604 is preferably connected to the grounding element (not shown) upon which dipole antenna 600 is preferably disposed.

Each one of first and second microstrip feedlines 606 and 618 may optionally be enclosed by a metal enclosure (not shown), which metal enclosure serves to improve the cross-polarization of the ±45° polarizations of first and second pairs of dipole arms 602 and 604. A pair of isolation elements 630 may optionally be provided on PCB 603 between first and second pairs of dipole arms 602 and 604, for the purpose of improving the isolation therebetween.

It is appreciated that as a result of the above-described respective feed arrangements of first and second pairs of dipole arms 602 and 604, one arm 610, 622 of each one of first and second pairs of dipole arms 602, 604 is preferably fed and the other arm 614, 628 of each one of first and second pairs of dipole arms 602, 604 is preferably grounded and therefore preferably acts as a counterpoise arm.

It is a particular feature of a preferred embodiment of the present invention that dual-polarized dipole antenna 600 further preferably includes at least one conductive cruciform element mounted on first and second pairs of dipole arms 602, 604, here embodied, by way of example, as a conductive cruciform element 640 non-galvanically mounted upon first and second pairs of dipole arms 602 and 604 by way of a plurality of non-conductive posts 642. Cruciform conductive element 640 is preferably capacitively coupled to first and second pairs of dipole arms 602 and 604 and is preferably vertically offset therefrom by a distance much smaller than λ, wherein λ is a wavelength corresponding to the first frequency band of operation of dipole antenna 600. By way of example, only, cruciform conductive element 640 may be vertically offset from first and second pairs of dipole arms 602 and 604 by a distance of less than 0.03λ, preferably corresponding to a physical distance of less than approximately 5 mm.

Cruciform element 640 is preferably capacitively fed by way of first and second pairs of dipole arms 602 and 604 and preferably resonates in a second frequency band, which second frequency band preferably spans a higher frequency range than that of the first frequency band of radiation of first and second pairs of dipole arms 602 and 604. The second frequency band of radiation, arising from cruciform element 640, in combination with the first frequency band of radiation, arising from first and second pairs of dipole arms 602 and 604, forms a combined broad frequency band of radiation of dual-polarized dipole antenna 600. It is understood that cruciform element 640 thus functions to advantageously broaden the frequency band of radiation of dual-polarized dipole antenna 600 in both of the polarizations thereof. Dipole antenna 600, including cruciform element 640, may operate over a very broad frequency range spanning approximately 1710-2700 MHz. It is appreciated that multiple ones of dipole antenna 600 may be arranged in an array configuration, thus creating a dual-polarized broadband antenna array.

Cruciform element 640 preferably comprises a first conductive strip 644 and a second conductive strip 646 orthogonally intersecting therewith. It is appreciated that cruciform element 640 is preferably formed as a monolithic element and that the demarcation of first and second strips 644 and 646 is for reference purposes only. It is further appreciated that first and second conductive strips 644 and 646 may be mutually symmetrical, as seen in FIGS. 6A and 6B, or may alternatively be mutually asymmetrical.

As seen most clearly in FIG. 6B a point of intersection 648 of first and second conductive strips 644 and 646 is preferably co-linear with a point of intersection 650 of first and second pairs of dipole arms 602 and 604. An electrical length of each one of first and second pairs of dipole arms 602 and 604, as measured from a first tip of one of dipole arms 610, 622 to a second tip of the corresponding other dipole arm 614, 628 of each one of dipole pairs 602 and 604, is preferably generally equal to λ/2. It is appreciated that first and second pairs of dipole arms 602 and 604 may be mutually symmetrical, as illustrated in FIGS. 6A and 6B, or may alternatively be mutually asymmetrical.

An electrical length of each one of first and second conductive strips 644 and 646 is preferably less than λ/2. As a result of the smaller electrical length of each one of the conductive strips 644, 646 forming cruciform element 640, in comparison to the electrical length of each one of first and second pairs of dipole arms 602, 604, cruciform element 640 preferably resonates in a higher frequency band than that of first and second pairs of dipole arms 602, 604, thereby giving rise to the above-described band widening effect.

First and second conductive strips 644 and 646 may be vertically aligned with first and second pairs of dipole arms 602 and 604, such that a projection of first and second conductive strips 644 and 646 onto the plane of first and second pairs of dipole arms 602 and 604 overlaps with first and second pairs of dipole arms 602 and 604. It is appreciated, however, that first and second conductive strips 644 and 646 forming cruciform element 640 may alternatively be rotated about point 648 so as to be vertically non-aligned with respect to first and second pairs of dipole arms 602 and 604, such that a projection of first and second conductive strips 644 and 646 onto the plane of first and second pairs of dipole arms 602 and 604 does not overlap with first and second pairs of dipole arms 602 and 604.

It is an additional particular feature of a preferred embodiment of the present invention that dual-polarized dipole antenna 600 further preferably includes a first and a second vertical balun portion 660 and 662, preferably integrally formed within the body of antenna 600. Each one of grounded dipole arms 614 and 628 is preferably respectively connected to first and second vertical balun portions 660 and 662. Vertical balun portions 660 and 662 preferably each comprise a slotted portion 664 preferably having an electrical length generally equal to λ/4, wherein λ is a wavelength corresponding to the first frequency band of radiation of first and second pairs of dipole arms 602 and 604.

The integral formation of vertical balun portions 660 and 662 within dual-polarized dipole antenna 600 serves to advantageously simplify the feeding arrangement employed therein. This is in contrast to conventional dual-polarized dipole antennas, which antennas typically require complex feed networks formed separately from the body of the antenna. As a result of the grounding of one dipole arm 614, 628 of each pair of dipole arms 602 and 604 by way of vertical balun portions 660 and 662, each one of pair of dipole arms 602 and 604 is preferably directly grounded and is therefore particularly well-suited for use in electrically challenging environments, such as outdoors.

Dual-polarized dipole antenna 600 may be partially formed by a single bent metal template. The preferable partial formation of dual-polarized dipole antenna 600 by a single metal sheet results in dual-polarized dipole antenna 600 being particularly economical and simple to assemble and thus extremely well-suited for mass-production. Additionally, the integral formation of first and second balun portions 660 and 662 by portions of a metal sheet simplifies the feed arrangement of antenna 600 and minimizes the number of parts required therein, thereby further reducing the costs of manufacturing antenna 600.

It is appreciated that although dipole antenna 600 is shown in FIGS. 6A-6C to include only a single cruciform element 640, dipole antenna 600 may alternatively include more than one cruciform element 640, in order to further advantageously widen the bandwidth of operation of dipole antenna 600.

It will be appreciated by persons skilled in the art that the present invention is not limited by what has been particularly claimed hereinbelow. Rather, the scope of the invention includes various combinations and subcombinations of the features described hereinabove as well as modifications and variations thereof as would occur to persons skilled in the art upon reading the forgoing description with reference to the drawings and which are not in the prior art.

1. A dual-polarized dipole antenna comprising:
a first pair of dipole arms resonating in a first frequency band;
a second pair of dipole arms intersecting said first pair of dipole arms and arranged orthogonally with respect to said first pair of dipole arms, said second pair of dipole arms resonating in said first frequency band; and
at least one conductive cruciform element mounted on said first and second pairs of dipole arms and resonating in a second frequency band.

2. A dual-polarized dipole antenna according to claim 1 and also comprising a first feed for feeding said first pair of dipole arms and a second feed for feeding said second pair of dipole arms.

3. A dual-polarized dipole antenna according to claim 2, wherein said first and second feeds comprise coaxial cables.

4. A dual-polarized dipole antenna according to claim 2, wherein said first and second feeds comprise microstrip feedlines.

5. A dual-polarized dipole antenna according to claim 1, wherein said at least one conductive cruciform element is galvanically isolated from said first and second pairs of dipole arms.

6. A dual-polarized dipole antenna according to claim 5, wherein said at least one conductive cruciform element is capacitively coupled to said first and second pairs of dipole arms.

7. A dual-polarized dipole antenna according to claim 6, wherein said at least one conductive cruciform element is separated from said first and second pairs of dipole arms by an electrical distance of less than λ, wherein λ is a wavelength corresponding to said first frequency band.

8. A dual-polarized dipole antenna according to claim 7, wherein said at least one conductive cruciform element is separated from said first and second pairs of dipole arms by an electrical distance of less than 0.03λ.

9. A dual-polarized dipole antenna according to claim 6, wherein said at least one conductive cruciform element comprises a first conductive strip orthogonally intersected by a second conductive strip.

10. A dual-polarized dipole antenna according to claim 9, wherein each one of said first and second conductive strips has an electrical length of less than λ/2, wherein λ is a wavelength corresponding to said first frequency band.

11. A dual-polarized dipole antenna according to claim 1, wherein said at least one conductive cruciform element comprises two conductive cruciform elements.

12. A dual-polarized dipole antenna according to claim 1, and also comprising a first balun portion and a second balun portion.

13. A dual-polarized dipole antenna according to claim 12, wherein said first and second pairs of dipole arms and said first and second balun portions are formed by a single metallic template.

14. A dual-polarized dipole antenna according to claim 13, wherein said single metallic template comprises a single sheet of metal.

15. A dual-polarized dipole antenna according to claim 12, wherein said first and second balun portions are formed by a single metallic template.

16. A dual-polarized dipole antenna according to claim 15, wherein said single metallic template comprises a single sheet of metal.

17. A dual-polarized dipole antenna according to claim 15, wherein said first and second pairs of dipole arms are disposed on a non-conductive substrate.

18. A dual-polarized dipole antenna according to claim 17, wherein said non-conductive substrate comprises a printed circuit board substrate.

19. A dual-polarized dipole antenna according to claim 9, wherein said first and second conductive strips are vertically aligned with respect to said first and second pairs of dipole arms.

20. A dual-polarized dipole antenna according to claim 9, wherein said first and second conductive strips are vertically non-aligned with respect to said first and second pairs of dipole arms.
